(19) United States
(12) Patent Application Publication
(10) Pub. No.: US 2005/0104321 A1
(43) Pub. Date: May 19, 2005

(54) Trailer unit with a trailer, specifically a double axle trailer

(75) Inventors: Robert Koch, Bad Sooden Allendorf (DE); Kens Karasek, Kaufungen (DE)

Correspondence Address: JORDAN AND HAMBURG LLP, 122 EAST 42ND STREET, SUITE 4000, NEW YORK, NY, 10168, US

(73) Assignee: Huebner GmbH, Kassel (DE)

(21) Appl. No.: 10/979,621

(22) Filed: Nov. 2, 2004

(30) Foreign Application Priority Data
Nov. 15, 2003 (DE) 103 53 411.3
Mar. 13, 2004 (DE) 20 2004 003935.4

(51) Int. Cl. B60D 5/00

(52) U.S. Cl. 280/403

(57) ABSTRACT

The subject matter of the invention is a tractor unit with a double axle trailer (2), a connecting joint being provided between the trailer (2) and the tractor unit (1), said connecting joint being adapted to be readily releasably coupled to and uncoupled from the tractor unit (1) and a connection (10), which is surrounded by a bellows (11), being provided between tractor unit (1) and trailer (2).

### FIELD OF THE INVENTION

The present invention relates to a tractor unit with a trailer, specifically a double axle trailer. The term “vehicle” is meant to include both busses with trailers and trucks with trailers.

### DESCRIPTION OF THE PRIOR ART

In this context, what are termed articulated busses are known on the one side. In principle, such an articulated bus consists of two hinge-linked vehicle parts. To enable circulation of passengers between the two vehicle parts, a connection consisting of a gangway and of a bellows is provided between the vehicle parts. The trailing vehicle part hereby has an axle that is driven by the engine which, in the case of what is termed a pusher, is placed at the rear. So-called pullers also exist, these being busses in which the engine is placed in the region of the rear axle of the front vehicle part with said engine driving the rear axle of the front vehicle part. The advantage of the pusher over the puller is that the bus may in principle be configured as a low floor bus over its entire length. With a puller, this is not possible since the space needed therefore in the region of the articulation is not available because of the engine. In spite of the indisputable advantages of low floor articulated busses, specifically when configured as a pusher, a disadvantage that should be noted is that at certain hours such busses are running almost empty. This means that, at such times, it is very uneconomical to run such type busses.

In this respect, it has become known in the past to operate busses with a trailer, with said trailer being connected to the bus acting as the tractor unit by a mere drawbar. Such type combinations however have not been manufactured for about 40 years. One reason therefore is that the bus driver cannot see what happens in the trailer.

For economical reasons however, there is considerable interest in adapting the carrying capacity of busses to the daily fluctuation in the number of passengers.

Trucks are moreover known, more specifically trucks with a trailer. The trailers are usually coupled to the tractor unit via a drawbar and a jaw clutch. The trailer itself forms a unit that is independent of the tractor unit. If the tractor unit is to be loaded, this is only possible without the trailer, which means that the trailer must be uncoupled. This is complicated and also involves longer loading times. On the other hand, trailer vehicles definitely also have advantages, one of them being for example that the capacity may be adapted by uncoupling the trailer. Accordingly, in operating trucks, there also is considerable interest in having the possibility to adapt the transporting capacity to the existing capacity needs.

### BRIEF SUMMARY OF THE INVENTION

In so far, the invention suggests to provide a vehicle with a trailer, specifically a double axle trailer, a connecting joint being provided between the trailer and the vehicle, said connecting joint being adapted to be readily releasably coupled to the vehicle and a connection, which is surrounded by a bellows, being provided between vehicle and trailer.

As far as the bus is concerned, the idea underlying the invention was to provide a connection between bus and trailer so that the bus driver be given the possibility to exert an influence on what is happening in the trailer, in a manner very similar to that in an articulated bus.

For a truck, the advantages include:
The tractor unit and the trailer can be loaded simultaneously, meaning the trailer needs not be uncoupled. The bellows between trailer and tractor unit protects the connection between trailer and vehicle against the weather. The bellows prevents air turbulence from occurring between the tractor unit and the trailer, which reduces fuel consumption. The connection consisting of a gangway and a bellows is here also adapted to be releasably connected to the vehicle or to the trailer so that the trailer may be coupled to or uncoupled from the vehicle according to need. The gangway is more specifically releasably connected to one of the two vehicles, i.e., either the trailer or the tractor unit; the gangway may for example be disposed so that it may be folded upwardly.

As for the connecting joint, there is more specifically provided a crosswise arrangement of two joint arms that are each pivotally linked at their end to the corresponding vehicle. As compared to a drawbar, such a universal joint provided between the two vehicles has the advantage that the distance between the two vehicles may be minimized. Further, using such a universal joint, the extension width of the bellows is also kept small in cornering. By contrast, with a trailer having a conventional drawbar, vehicle parts that are thus joined together cannot be connected through a bellows since, in cornering, the bellows would extend so much in the outer region that it would tear. This means that it is by disposing what is termed a universal joint between the two vehicles, meaning e.g., between bus and trailer, that it becomes possible to connect the trailer and the tractor unit via a bellows.

As already explained above, the trailer is intended to have a double axle configuration. In order to make certain that for example a bus of an overall length of about 20 meters and having such a trailer is still capable of traveling around the unit circle, meaning a circle of 12.50 meters, there is provided that at least one of the rear axles of the trailer be steerable. That is, it is also possible to configure the front axle of the trailer to be steerable in addition to the rear axle(s). There is more specifically provided that the steering angle of the rear axle wheels is dictated by the position of the joint arms of the connecting joint, meaning of the universal joint.

There is more specifically provided hereby that the steering angle of the rear axle is dictated by a linkage mechanically connecting the rear axle to the joint. To facilitate coupling of the trailer to the universal joint on the vehicle, there is provided that the joint arms be connected on each end by a tie bar which is adapted to be coupled to the vehicle.

According to a particular feature of the invention, there is provided with respect to coupling that for coupling the tie bar of the trailer to the vehicle there are provided at least one, but preferably two, spaced-apart coupling assemblies having two coupling members each, said two coupling members being adapted to hydraulically, pneumatically, mechanically or electrically releasably engage with one another. The important point hereby is that coupling of the two vehicles or vehicle parts is to be carried out without having to manually intervene in the coupling process. The driver of the tractor unit, of the bus for example, should instead be capable of initiating and performing the coupling process from the driver's cabin without being dependent on the help of third persons or without the driver having to get off the vehicle for performing coupling or uncoupling. As already explained, the coupling assembly itself preferably comprises two coupling members with the one coupling member being disposed on the tie bar and comprising an eye at its end. The other coupling member, which is disposed on the tractor unit, comprises a pin that is engageable into and disengageable from the eye of the one coupling member and is axially movably retained by a receiving element disposed on the bus.

According to a particular feature of the invention, there is provided that the eye is configured like a cone. Correspondingly, the pin comprises a cylindrical bolt on which a cone configured to conform to the eye is disposed in the region of the eye. Meaning that, as the pin or the cylindrical bolt is being engaged into the eye of the one coupling member, a substantially zero clearance fit is provided between the two coupling members.

In order to prevent the pin or the cylindrical bolt from being loaded on one side only, there is provided, in accordance with another feature of the invention, that the pin comprises a cylindrical extended portion that is receivable by the receiving element. It is obvious therefrom that the receiving element is configured in the shape of a fork and accordingly comprises two legs disposed in a spaced-apart relationship with the legs serving to receive the pin.

In order to facilitate coupling, the receiving element, which is disposed on the bus, comprises, on its side turned toward the tie bar, an admission hopper for the one coupling member.

According to another feature, on the receiving element there is provided a pivotal lever that communicates with the pin for engaging and disengaging the bolt, said pivotal lever being hydraulically, pneumatically, mechanically or electrically actuatable.

The invention will be understood better upon reading the exemplary description accompanying the drawing wherein:

### BRIEF DESCRIPTION OF THE SEVERAL VIEWS OF THE DRAWING

FIG. 1 is a side view of a tractor unit with trailer, the tractor unit and the trailer being attached together by a connection;

FIG. 2 is a schematic top view showing the combination according to FIG. 1 and in which there can be seen the bellows, the gangway and the joint;

FIG. 3 is a rear view of the trailer, with the rear view of the tractor unit being configured according to the same principle with regard to the closure of the passage opening;

FIG. 4 is a perspective illustration of the joint;

FIG. 5 is a top view of the joint;

FIG. 6 shows how the axles of the trailer are steered by a linkage that is disposed on the joint.

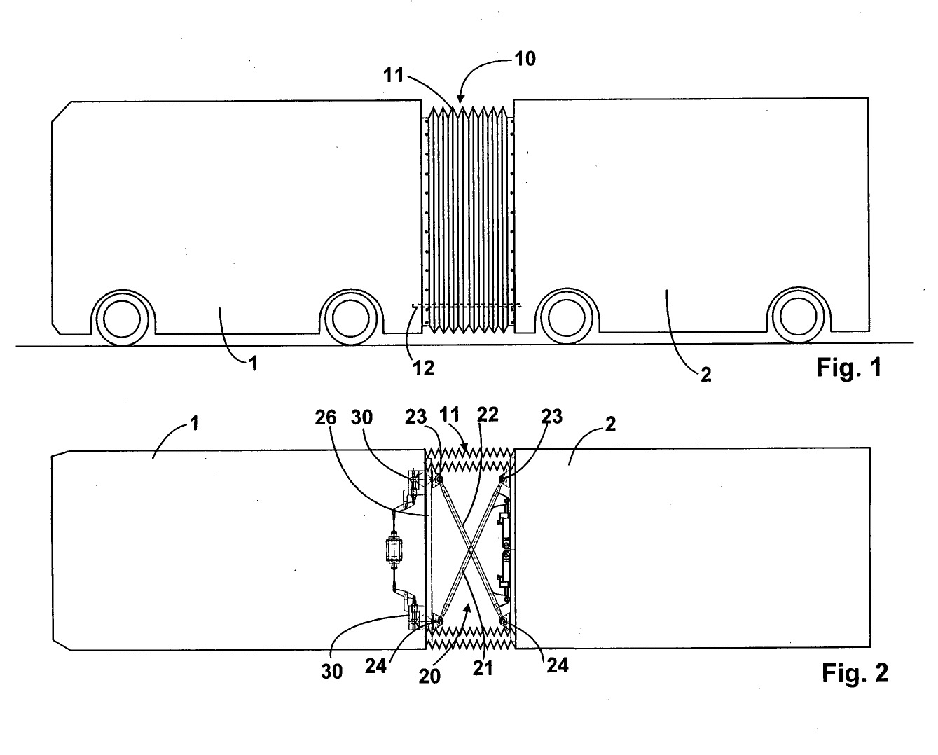

### DETAILED DESCRIPTION OF THE INVENTION

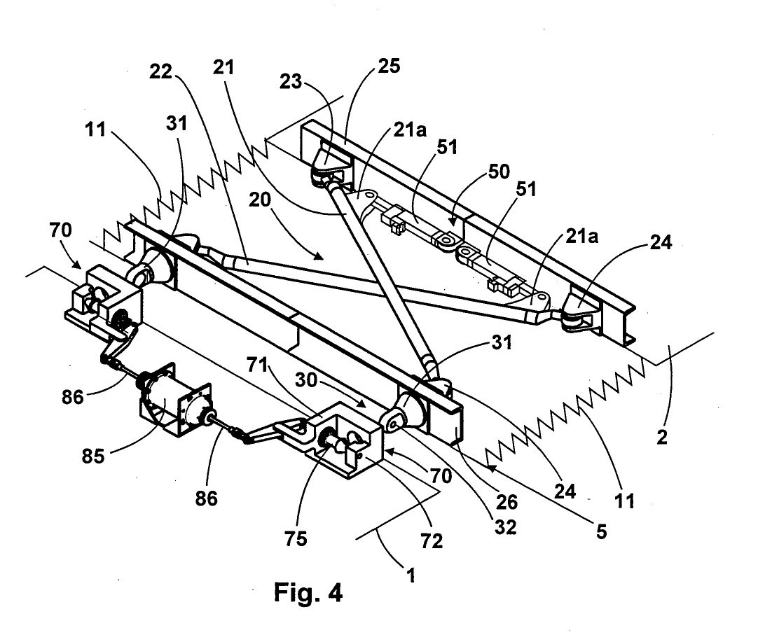

From the FIGS. it can be seen that the tractor unit 1 receives the double axle trailer 2 so that it may be coupled thereto. The parting plane between the tractor unit and the trailer is indicated by the arrow 5. Between the tractor unit 1 and the trailer 2 there is provided a connection 10, said connection 10 consisting of a bellows 11 and of an intercar gangway 12. The intercar gangway 12 is hereby foldably secured to the trailer via hinges 12a so that it may be folded upwardly when not in use. To form an articulated connection between the trailer and the tractor unit, what is termed a universal joint 20 (FIG. 4) is provided. Said universal joint includes two arms 21 and 22 that are disposed diagonally relative to each other and are articulated at their one end on the tie bar 25 of the trailer 2 by means of joints 23, 24, said joints being received on the other end by a tie bar 26. The joints 23, 24 may also be disposed directly on the chassis of the trailer.

In the region of the trailer i.e., of tie bar 25, the joint arms 21, 22 comprise a damper unit 50. The damper unit 50 comprises two piston and cylinder drive means 51 that are articulated on the one side to the vehicle and on the other side to the joint arms through a lug 21a, 22a disposed on the respective one of the joint arms 21, 22. The piston and cylinder drive means 51 may hereby be of a very short construction, thus being capable of exerting relatively high damping forces onto the joint arms 21, 22. The intercar gangway 12 can moreover be seen, said gangway having been configured to be circular in the region of the rear car (arrow 60) in order to permit rotation of the rear car about the front car. Further, the pleated bellows 11 is schematically shown (FIG. 4).

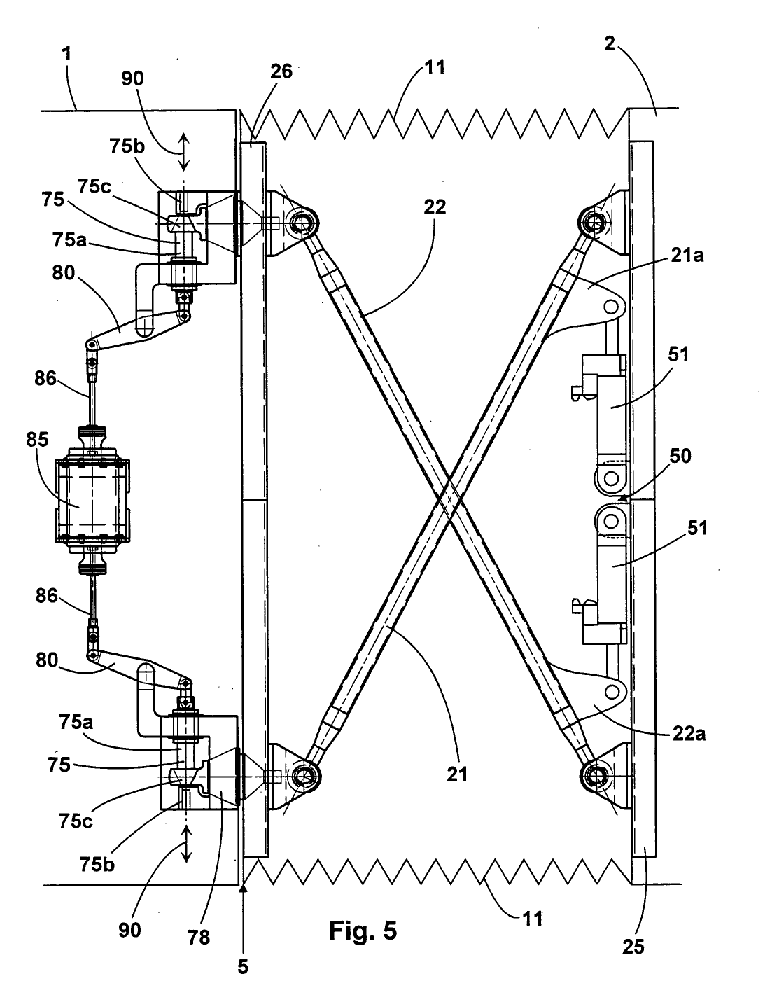

The way the trailer is coupled to the tractor unit is best shown in the FIGS. 4 and 5. The important point thereby is that the joint with the joint arms remains on the trailer. The coupling of the trailer 2 to the tractor unit 1 by means of the tie bar 26 will now be discussed herein after.

The tie bar 26 of the trailer 2 has two spaced-apart coupling assemblies, each having the coupling member 31, the coupling members 31 each having at their end a horizontally oriented eye 32. Receiving elements 70 are provided on the chassis of the tractor unit 1 so as to correspond to the coupling members 31. Such a receiving element 70 comprises two legs 71 and 72 that are oriented so as to form a fork. The two legs 71 and 72 serve to receive the pin, which is generally indicated at 75. The pin 75 comprises two cylindrical portions 75a and 75b, a cone 75c being disposed between the two portions 75a and 75b, said cone engaging into the also conically configured eye 32 where the conical fit provides for a substantially zero clearance fit between the coupling members. Having its cone fitted within the eye 32, the pin 75 itself is retained by the two legs 71 and 72 so that the bolt is prevented from deforming under an applied load.

In order to facilitate engagement of the one coupling member disposed on the tie bar 26 into the receiving element during coupling of the trailer, said receiving element has a conical hopper 78 opening in the direction of the tie bar 26. To engage and disengage the pin 75, a pivotal lever 80 is disposed on the receiving element 70, said pivotal lever communicating through the linkage 86, as already explained, on the one side with the bolt 75 and on the other side with a piston cylinder drive means 85 so as to move the pin 75 in the direction pursuant to arrow 90 by pivoting the lever.

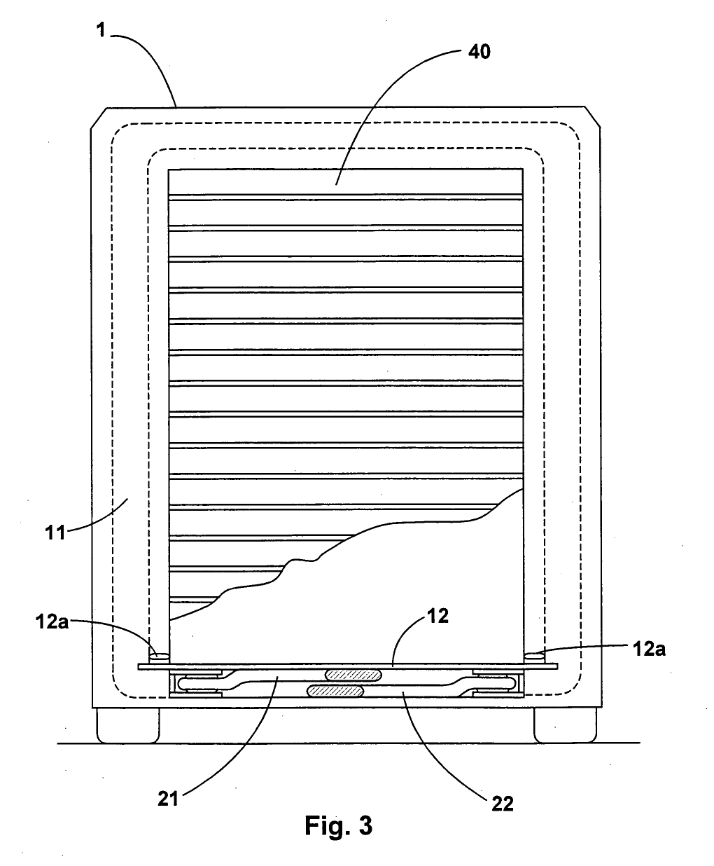

A blind 40 for closing the opening of both the tractor unit and the trailer after uncoupling of the trailer is provided (FIG. 3).

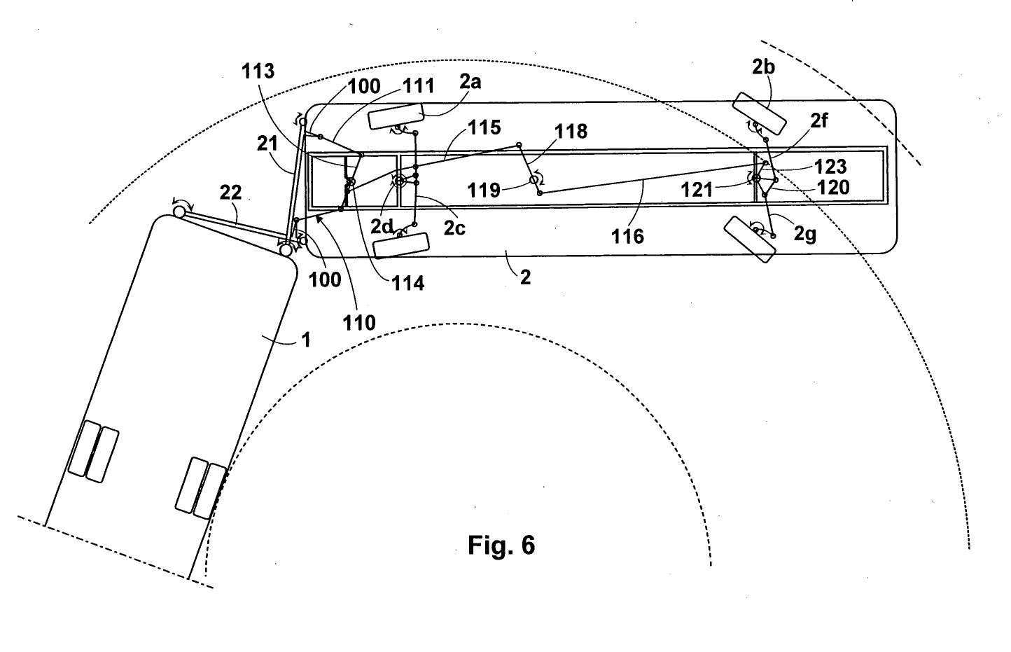

FIG. 6 shows how the linkage, which is connected to the two joint arms, steers the axles of the trailer. The illustration in FIG. 6 is only schematic and serves to explain the principle of steering. On both arms 21, 22 of the joint 20 there is provided a joint bearing pillow 100 on a respective one of the confronting ends, the steering linkage 110 being articulated on said joint bearing pillows. The steering linkage 110 has the two tie rods 111, 112 that are in turn articulated together via a coupling rod 113. At its center, the coupling rod 113 is connected to the trailer by a pivot bearing 114. The transmission linkage 115, which is rotatably connected to the transmission linkage 116 through a pivotal arm 118 pivotally disposed on the trailer, is articulated to the coupling rod. The two linkages 115, 116 are rotatably disposed on the end of the pivotal arm 118.

The pivotal arm 118 itself is also rotatably disposed on the trailer 2. The rotary joint 119 is mounted on the trailer in such a manner that, for a dictated position of the joint 20, the steering angle position of the wheels 2a of the front axle of the trailer and that of the wheels 2b of the rear axle are dictated. The steering angle of the front and of the rear wheels may thereby differ in order to make certain that the in particular bus is capable of traveling around the unit circle with its trailer. In this respect, the rotary joint 119 must not retain the pivotal arm in the center. The transmission linkage 115 is pivotally disposed off center on the front axle 2c so that it is capable of pivoting the front axle 2c about its pivot point 2d.

The rear axle of the trailer comprises two joint levers 2f, 2g that are articulated together by a steering head 120. The steering head 120 has a substantially triangular geometry and is mounted at one vertex to the trailer, being thereby rotatably carried on the pivot bearing 121. The steering head 120 comprises, in the region of the pivot bearing 121, a pivotal lever 123 that is pivotally coupled at one end to the transmission linkage 116. It is obvious therefrom that the two pairs of wheels 2a, 2b can be steered with one linkage.

1. A tractor unit with a double axle trailer, a connecting joint provided between the trailer and the tractor unit, said connecting joint being adapted to be readily releasably coupled to and uncoupled from the tractor unit and a connection, which is surrounded by a bellows, being provided between the tractor unit and the trailer.

2. The tractor unit in accordance with claim 1, wherein the connecting joint includes two joint arms that are oriented crosswise and are pivotally hinge-linked at their end to the corresponding tractor unit and trailer.

3. The tractor unit in accordance with claim 1, wherein the joint arms are joined together at their end by a tie bar, said tie bar being adapted to be coupled to and uncoupled from the tractor unit.

4. The tractor unit in accordance with claim 2, wherein a rear axle of the trailer is configured to be steerable, the steering angle of the wheels of the rear axle being dictated by the position of the joint arms of the connecting joint.

5. The tractor unit in accordance with claim 4, wherein the steering angle of the rear axle is dictated mechanically by a linkage connecting the rear axle with the joint.

6. The tractor unit in accordance with claim 1, wherein the tractor unit comprises at the rear a closable door pocket space and the trailer correspondingly comprises a closable door pocket space for connecting with the connection.

7. The tractor unit in accordance with claim 1, wherein the connection comprises a foldable gangway.

8. The tractor unit in accordance with claim 3, wherein for coupling the tie bar of the trailer to the tractor unit, there are provided at least one, preferably two, spaced-apart coupling assemblies having two coupling members each, said two coupling members being adapted to hydraulically, pneumatically, mechanically or electrically releasably engage with one another.

9. The tractor unit in accordance with claim 8, wherein the one coupling member is disposed on the tie bar and comprises an eye at its end.

10. The tractor unit in accordance with claim 9, wherein the other coupling member disposed on the tractor unit comprises a pin that is adapted to hydraulically, pneumatically, mechanically or electrically engage with and disengage from the eye, said pin being axially movably retained in a receiving element.

11. The tractor unit in accordance with claim 10, wherein the eye is configured like a cone.

12. The tractor unit in accordance with claim 11, wherein the pin is configured to be cylindrical and comprises in the region of the eye a cone configured to conform to the eye.

13. The tractor unit in accordance with claim 12, wherein the pin comprises a cylindrical extended portion that adjoins with the cone and is receivable by the receiving element.

14. The tractor unit in accordance with claim 10, wherein the receiving element comprises, on its side turned toward the tie bar, an admission hopper for the one coupling member.

15. The tractor unit in accordance with claim 13, wherein the receiving element is configured in the shape of a fork and comprises two spaced-apart legs, said legs serving to receive the pin.

16. The tractor unit in accordance with claim 10, wherein for engaging and disengaging the bolt, there is provided on the receiving element a pivotal lever that communicates with the pin, said pivotal lever being hydraulically, pneumatically, mechanically or electrically actuable.
